(19) United States
(12) Patent Application Publication
(10) Pub. No.: US 2012/0312755 A1
(43) Pub. Date: Dec. 13, 2012

(54) MOBILE CLARIFIER AND SLUDGE DEWATERING SYSTEM FOR ONSITE WASTE WATER TREATMENT

(75) Inventors: Dustin RYAN, Cochrane (CA); Kevin LAUMAN, Calgary (CA); Jacob HALLDORSON, Calgary (CA)

(73) Assignee: AQUA-PURE VENTURES INC., Calgary (CA)

(21) Appl. No.: 13/492,526

(22) Filed: Jun. 8, 2012

Related U.S. Application Data
(60) Provisional application No. 61/495,719, filed on Jun. 10, 2011.

(51) Int. Cl. C02F 1/00; B01D 15/00

(52) U.S. Cl. 210/749; 210/198.1

(57) ABSTRACT

A waste water clarification system is mounted on two road-transportable trailers which meet height and weight regulations and require no additional permitting. An elongate, low-profile clarifier having inclined plate packs supported therein utilizes the dropped bed portion of the first trailer to maximize the usable height to meet transport requirements while optimizing clarification of the waste water therein. Sludge produced in the clarifier section is thickened by gravity in a thickening section mounted on the first trailer. The thickened sludge is delivered to dewatering apparatus on the second trailer which also houses a lift tank for clarified water, chemical storage tanks and a control room for system control apparatus. Linear conveyors, in steep-walled troughs in the bottoms of the clarifier and thickening sections, slowly move the sludge to outlets therein, the speed being slow enough that a sludge blanket which develops in or above the troughs is not disrupted.

### CROSS-REFERENCE TO RELATED APPLICATIONS

This application claims the benefit of U.S. Provisional Patent application Ser. No. 61/495,719, filed Jun. 10, 2011, the entirety of which is incorporated herein by reference.

### FIELD OF THE DISCLOSURE

Embodiments are related to apparatus and systems for clarifying waste water and for dewatering of sludge produced as a result thereof, and more particularly, to mobile apparatus and systems for dewatering waste waters produced in the oil and gas industry.

### BACKGROUND

Water is consumed and waste water is produced in a variety of different industrial and other processes, including the oil and gas industry. There is great interest in the ability to clarify and recycle waste water to reduce the demand on water resources.

Waste water produced onsite in the oil and gas industry must either be transported from the site for treatment or disposal, or it may be treated onsite. A variety of known apparatus are required to effectively clarify the waste water to produce water of sufficient quality to be reused. Conventionally, treatment apparatus comprises tall clarifiers, such as inclined plate clarifiers, which have a minimal footprint, but have a significant height to take advantage of gravity. The inclined plate packs separate the solids from the liquids permitting the solids to fall therethrough. The inclined plate packs are mounted above tall, generally V-shaped containments to permit gravity thickening of the separated solids collected therein. By way of example, inclined plate settlers, such as those available from Metso Corporation, Helsinki, Finland, range in height from about 11.5 ft to about 29 ft, in length from about 9 ft to about 29 ft, and in width from about 4 ft to about 25 ft. Department of Transport requirements restrict the size and weight of equipment which is transported on roadways. To utilize such cumbersome clarifiers onsite, and to meet Department of Transport (DOT) requirements, the clarifiers are transported as modular components which require assembly onsite after delivery thereto. Onsite treatment is a temporary project and the expense for transport and the man hours required for assembly and disassembly of such clarifiers is significant.

Further, sludge created in the clarifier must be further processed to recover as much water as possible and to dispose of the solid waste. As with the waste water, the sludge must either be transported for treatment in an offsite facility or the sludge must be treated onsite. If treated onsite, even more equipment for said treatment must be transported and assembled onsite and subsequently disassembled and re-deployed for use elsewhere.

Clearly, there is a need for apparatus and systems which can be readily transported from site to site and which eliminate the need to transport large volumes of potentially hazardous waste water, or sludge resulting therefrom, to treatment facilities.

### SUMMARY

Embodiments disclosed herein utilize one or more road-transportable trailer beds to mobilize a waste water treatment system comprising a chemical section, a clarifier section and a thickening section, as well as dewatering apparatus and a variety of auxiliary apparatus, including but not limited to, pumping equipment, chemical and clarified water storage tanks, control apparatus and the like. The system substantially produces two products; clarified water for reuse and dewatered solids for disposal. The clarifier section is elongate and has a relatively low profile compared to conventional clarifiers. Steep walled, V-shaped troughs having linear conveyors therein are used at a bottom of the clarifier section and the thickening section to collect and move sludge longitudinally along below inclined plate packs in the clarifier section and the settling chamber in the thickening section. An upflow rate through the inclined plate packs is relatively low to assist in solids removal efficiency in the clarifier section. Some low-solids water from the thickening section is flowed back to the clarifier section to aid in dewatering of the sludge therein. The dewatering apparatus and auxiliary equipment is housed on a second trailer.

In a broad aspect, a mobile, waste water treatment system comprises: a first trailer having a chemical chamber for mixing chemicals with a waste water stream for forming a treated waste water stream. An elongate, low-profile clarifier section receives the treated waste water stream therein. The clarifier section comprises: a clarifier chamber having one or more elongate, inclined plate packs supported therein. The clarifier chamber is fluidly connected to the two or more chemical chambers for receiving the treated waste water stream therefrom. A water outlet discharges clarified water from the top of the clarifier chamber. One or more longitudinally extending, low-profile, steep-walled, generally V-shaped troughs in a bottom of the clarifier chamber collect sludge settling therein. One or more linear conveyors positioned in the one or more generally V-shaped troughs move the sludge, longitudinally therealong, to a distal end. A thickening section comprises: a thickening chamber which receives the sludge from the clarifier chamber's distal end at a mid-point inlet, midway a length and height of the thickening chamber. One or more longitudinally extending, steep-walled, generally V-shaped troughs in a bottom of the thickening chamber collect thickened sludge depositing therein. One or more linear conveyors in the one or more generally V-shaped troughs move the thickened sludge longitudinally therealong to a sludge outlet. A low-solids water discharge occurs from a top of the thickening section to the clarifier chamber. A second trailer has at least dewatering apparatus for receiving the thickened sludge from the thickening section on the first trailer and for removing water therefrom.

In another broad aspect, a method for integrating a waste water treatment system on at least one road-transportable trailer-bed, comprises providing a trailer-bed having a raised pin-end, a central drop-bed portion and a raised distal end. Chemical chambers are positioned over the raised pin-end of the trailer-bed. A clarifier section, comprising one or more elongate, inclined plate packs supported therein, is positioned in the central drop-bed portion adjacent the two or more chemical treatment chambers and fluidly connected thereto. The clarifier section has a height sufficiently low so as to be within unpermitted road transport allowance. The clarifier section has one or more longitudinally-extending, linear, V-shaped troughs having linear conveyors extending along a bottom thereof positioned below the one or more elongate, inclined plate packs for receiving and transporting sludge collected therein. A thickening section is positioned downstream from the clarifier section and fluidly connected thereto, the thickening section spanning between a remaining portion of the central drop-bed portion and the raised distal end, forming an equipment space in the central drop-bed portion therebelow. The thickening section has one or more longitudinally-extending, linear, V-shaped troughs having the linear conveyors therein for receiving and transporting the sludge collected therein. The linear conveyors in the clarifier section and thickening section are moved at a slow, uniform, continuous rate of speed for minimizing disturbance of the sludge therein when transported thereby.

### BRIEF DESCRIPTION OF THE DRAWINGS

FIG. 1A is a plan view of a trailer-mounted road-transportable waste water clarification system, according to an embodiment, comprising a first, clarifier trailer for housing chemical mixing chambers, a clarifier section, and a sludge thickening section and a second, auxiliary trailer for housing at least sludge dewatering apparatus and additional apparatus;

FIG. 1B is a perspective view of the system according to FIG. 1A;

FIG. 2 is a cross-sectional view of the first clarifier trailer according to FIG. 1A;

FIG. 3 is a top, perspective view of the clarifier trailer of FIG. 1A;

FIG. 4 is a cross-sectional view of the first clarifier trailer according to FIG. 2, flow of waste water, liquid including clarified water and solids or sludge being illustrated therein;

FIGS. 5A and 5B are cross-sectional views of the clarifier section and the thickening section, respectively, illustrating generally V-shaped troughs and conveyors therein, a height of the clarifier section being greater than that of the thickening section, inclined plate packs and a plate-carrying box having been removed from the clarifier section for clarity;

FIG. 6 is a cross-sectional view of the clarifier section along section lines A-A according to FIG. 2, inclined plate packs being supported in a plate box suspended from peripheral walls of the clarifier section;

FIG. 7 is a fanciful partial perspective view of generally V-shaped troughs and conveyors therein for moving sludge and a sludge blanket longitudinally therealong;

FIG. 8 is a color modeling illustrating flow vectors, generated using computational fluid dynamic modeling (CFD modeling), in a flocculation chamber and in the clarifier section according to FIG. 4;

FIG. 9 is a color, perspective view, generated using CFD modeling, illustrating an overflow rate profile in the clarifier section of the first trailer of FIG. 4;

FIG. 10 is a plan view according to FIG. 9;

FIG. 11 is a cross-sectional view along section lines B-B according to FIG. 2, illustrating a stilling plate between the flocculation chamber and the clarifier section;

FIG. 12A is a perspective view according to FIG. 3, the plate-carrying box housing the inclined plates being removed for clarity;

FIG. 12B is a perspective view of the plate-carrying box housing the inclined plates having been removed from the clarifier section according to FIG. 12A;

FIG. 13 is a perspective view of the plate box of FIG. 12B, the inclined plates having been removed for clarity; and

FIGS. 14A to 14C are schematics illustrating the piping and control of liquid and solids flow between the clarifier trailer and the auxiliary trailer and the components mounted on each, more particularly,

FIG. 14A is an overall schematic;

FIG. 14B is a partial schematic of part A of FIG. 14A, enlarged for readability; and

FIG. 14C is a partial schematic of part B of FIG. 14A, enlarged for readability.

### DETAILED DESCRIPTION OF THE PREFERRED EMBODIMENTS

Embodiments of a mobile waste water treatment apparatus and system are described herein for the removal of total suspended solids (TSS), and select dissolved solids, from industrial or oilfield waste waters. The apparatus and system are trailer-mounted on at least one road-transportable trailer-bed for transport to the site without the need for special permitting, operated onsite in conjunction with conventional operations such as oilfield completion activities, with minimal assembly and are, thereafter, decommissioned and relocated to the next site.

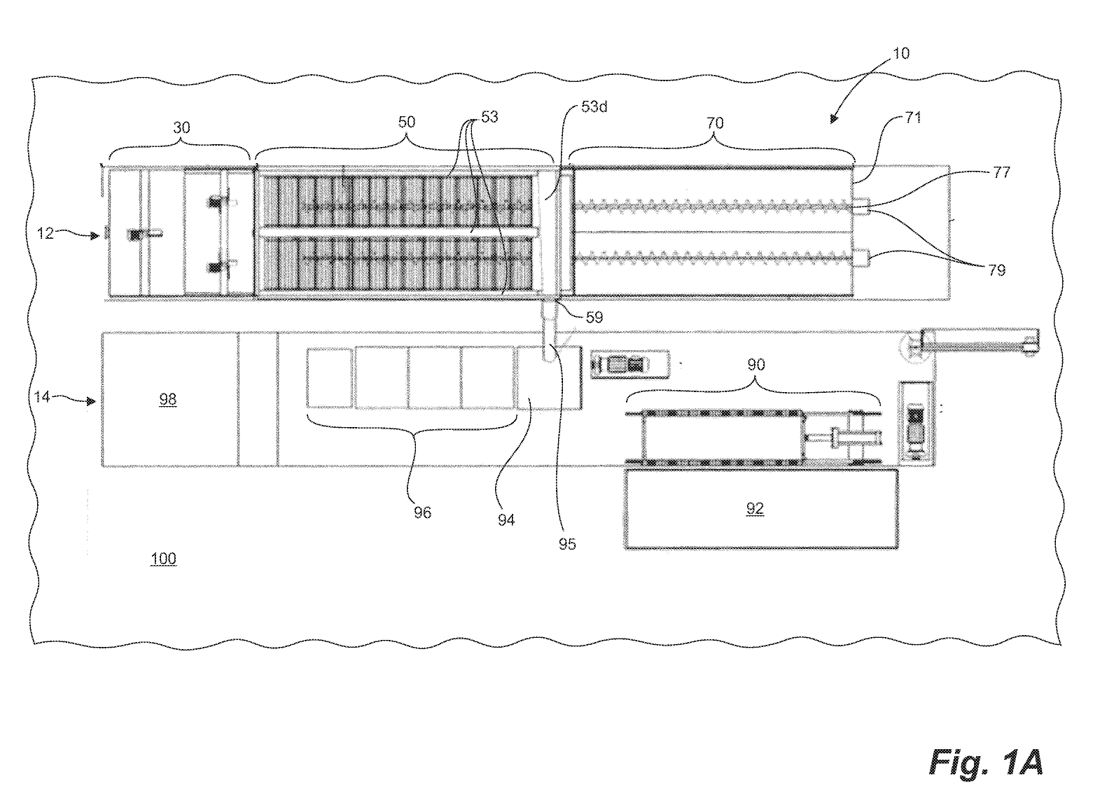

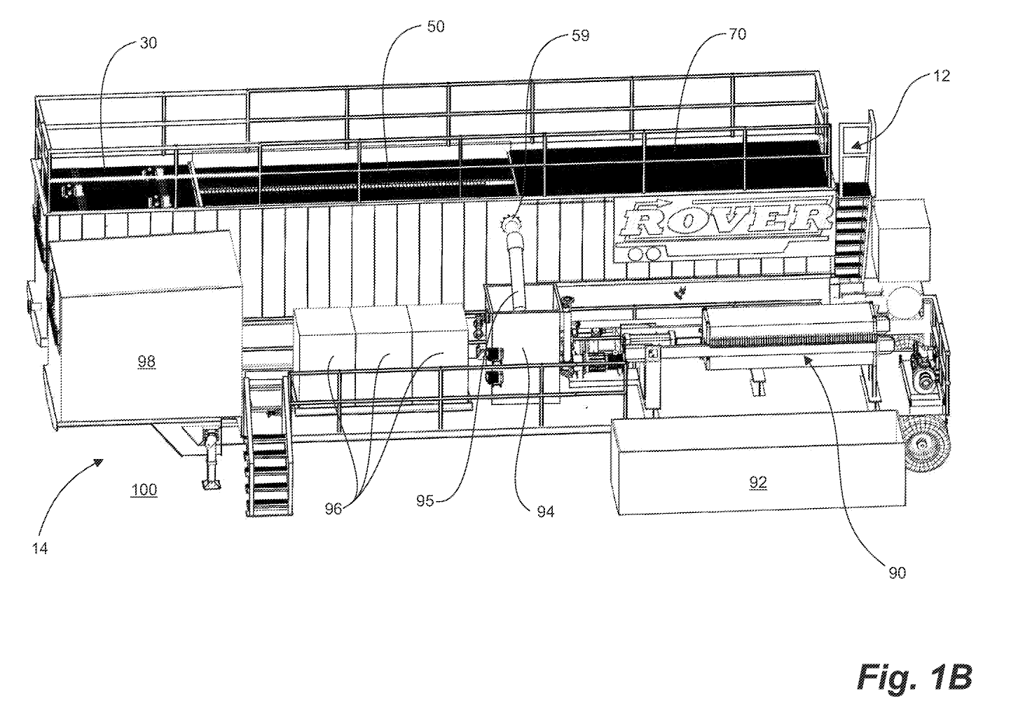

In one embodiment, as shown in FIGS. 1A and 1B, the system 10 is mounted on first and second DOT-certified trailers 12,14. The overall system 10 and method for integrating the system on the road-transportable trailers 12,14 combines a chemical treatment section 30, a clarifier and sludge dewatering section 50 comprising at least a reduced-height, elongate inclined plate pack clarifier 52 and sludge removal conveyors 54, and a thickening section 70. The system 10 also comprises additional sludge thickening and dewatering apparatus, associated chemical storage and control systems. The system 10 has a design treatment capacity of about 10,000 barrels per day and has a small footprint, utilizing a pad of about 20 ft×55 ft, onsite.

In embodiments, to meet Canadian and US DOT size restrictions, the semi-trailer-mounted equipment does not exceed 102 inches in width, 162 inches in height and 53 feet in length. Embodiments of the system 10 are suitable for non-permitted transport in Canada and the USA.

The first trailer 12 houses the chemical mixing section 30, the clarifier section 50 and the thickening section 70. In order to meet the DOT height restriction, the clarifier and thickening sections 50,70 were modified significantly from conventional designs. The second, auxiliary trailer 14 houses at least dewatering equipment 90, such as filter presses, centrifuges, belt presses, screw presses and the like for dewatering the thickened sludge S, as well as the chemical storage 96 and control systems, housed in a control room 98.

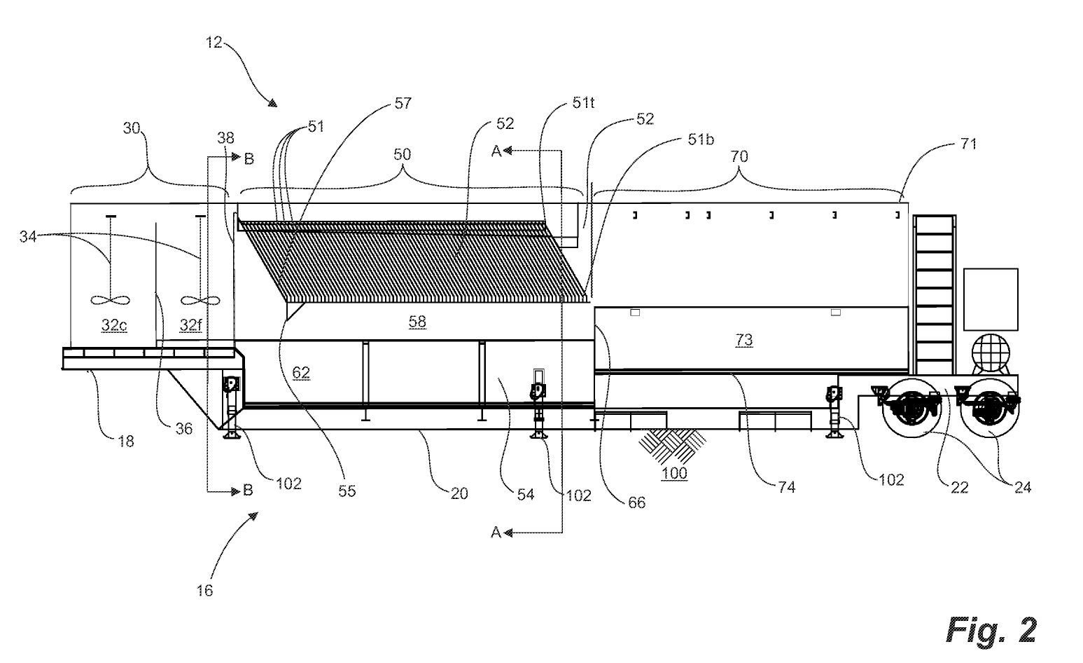

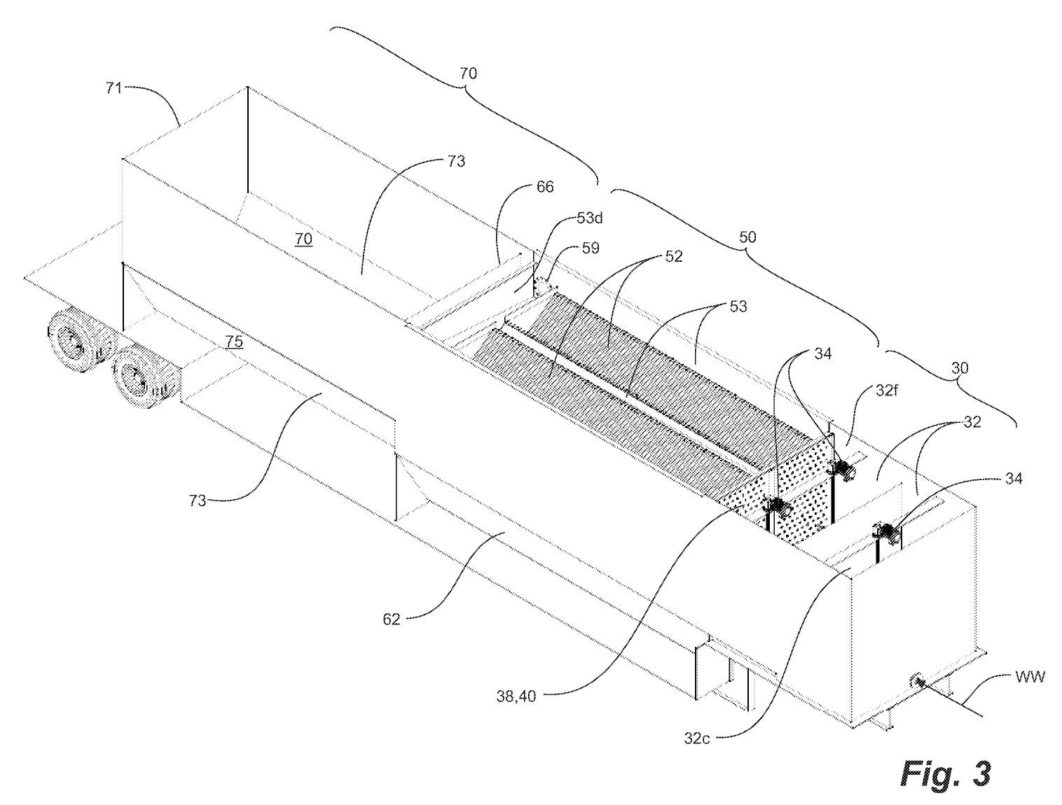

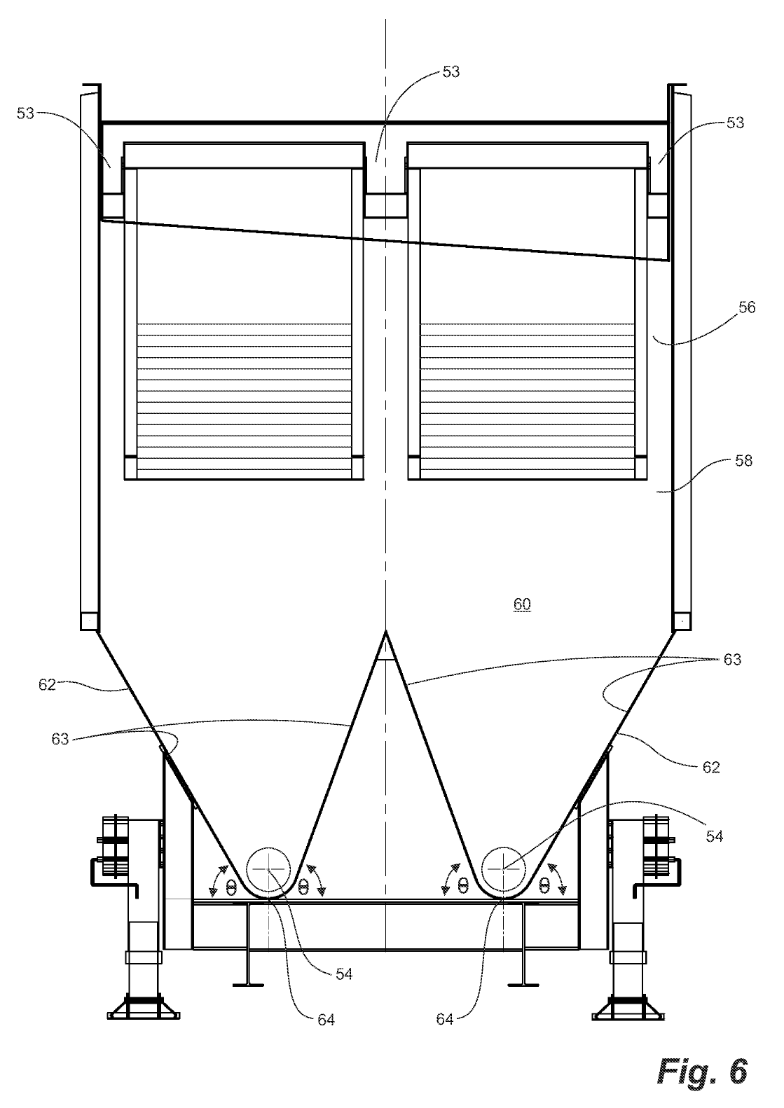

Having reference to FIGS. 2 to 6, the first, clarifier trailer 12 advantageously utilizes the shape of a drop-bed structure 16 of the semi-trailer 12 to accommodate the apparatus mounted thereon and to maximize performance of the clarifier section 50. The chemical mixing section 30 is positioned at a pin end 18 of the trailer-bed 16 which has less usable height, the chemical mixing section 30 not being sensitive to height issues. The clarifier section 50 is positioned in a lower or dropped, central section 20 of the trailer-bed 16 which provides the greatest available height for the reduced-height clarifier 52 and associated sludge removal conveyors 54. The thickening section 70, which does not require the additional height afforded by the dropped section 20, spans the remainder of the dropped section of the trailer-bed 20 and extends onto a raised rear or distal end 22 of the trailer-bed 16, which is raised to accommodate rear wheels 24 of the trailer 12. Advantageously, the remainder of the dropped section 20 below the thickener section 70 is utilized for accommodating pumps and additional, auxiliary equipment.

### Chemical Mixing Section

Having reference again to FIGS. 1A to 4, the chemical mixing section 30 comprises a chemical chamber 32 for mixing chemicals with the waste water WW.

In embodiments the chemical mixing chamber 32 comprises at least two fluidly connected chemical chambers 32 mounted on the pin end 18 of the first trailer 12. The two or more chemical chambers 32 comprise at least one coagulation chamber 32c for the addition of a coagulant and at least one flocculation chamber 32f for the addition of a flocculent. Each of the two or more chemical chambers 32 is equipped with one or more agitators or mixers 34 for mixing waste water WW received therein with the added chemicals.

Waste water WW is pumped into the at least one coagulation chamber 32c to which the coagulant is added. The treated waste water WW is agitated therein to mix and contact the coagulant with suspended solids and the like in the waste water WW. The waste water WW then flows over a weir 36 to the at least one chemical flocculation chamber 32f. The flocculent, such as a polymer, is added therein to the coagulant-treated waste water WW, forming a treated waste water stream WW_{T}. The treated waste water stream WW_{T} is mixed in the second, flocculation chamber 32f to encourage the formation of floc therein.

The speed of agitation of the one or more mixers 34 in each of the two or more chemical chambers 32 is adjustable depending upon the solids content of the waste water WW and the chemicals added, as is understood by those of skill in the art.

The treated waste water stream WW_{T} flows through an inlet 38, such as a turbulence-reducing perforated stilling plate 40, discussed in greater detail below, into the clarifier section 50.

### Clarifier And Sludge Dewatering Section

As previously stated, conventional inclined plate clarifiers are designed to be tall and to have a minimal footprint in order to be neatly fit into industrial facilities. Conventional clarifier design is typically not restricted by height restrictions and therefore the clarifiers can be tall to take maximal advantage of gravity to allow for a degree of sludge thickening in the lower section of the clarifier.

In an embodiment herein, as shown in FIGS. 1A to 6, the clarifier section 50 is elongate, has a low profile and is sized to fit onto the narrow, long clarifier trailer 12 in order to meet DOT requirements. The clarifier section 50 is positioned adjacent the chemical section 30 for receiving treated waste water WW_{T} therefrom. One or more elongate, inclined plate packs 52, comprising a plurality of inclined plates 51 and collection weirs 53 formed thereabout, are mounted in an upper portion 56 of a clarifier tank or chamber 58. To achieve adequate separation and solids removal in the low-profile clarifier section 50, being at least comparable to conventional clarifiers, sludge removal conveyors 54, are installed in a lower portion 60 of the clarifier chamber 58 below the inclined plate packs 52.

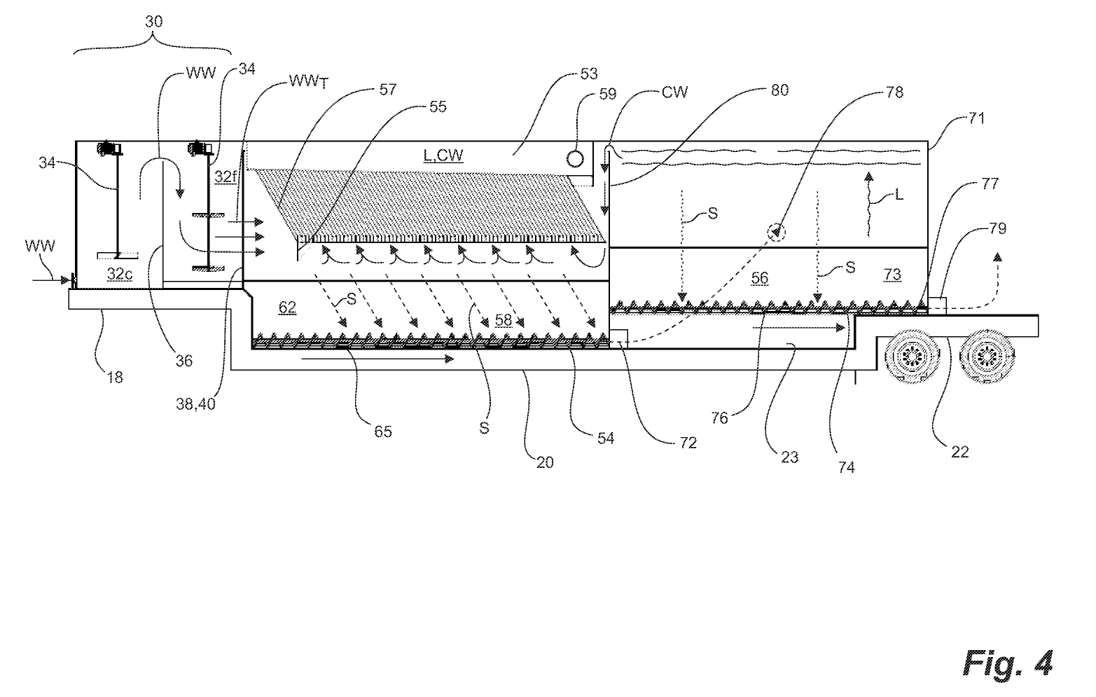

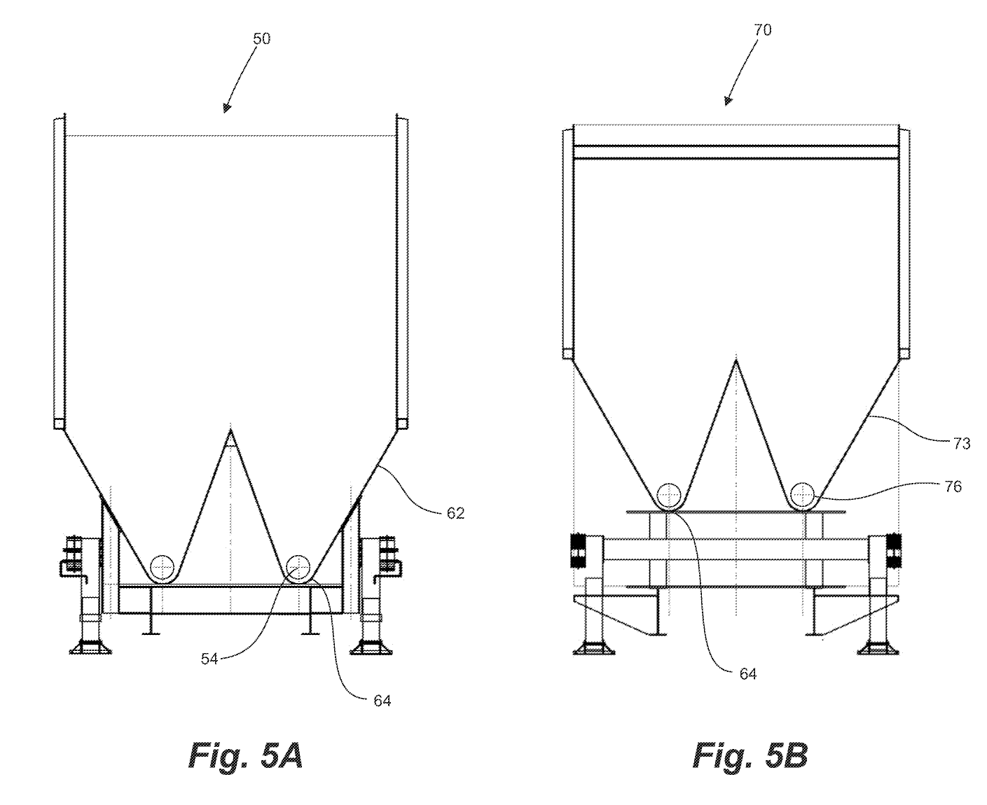

In embodiments, as shown in FIG. 1A, FIG. 4, and FIGS. 5A to 7, the sludge removal conveyors 54 are one or more side-by-side linear sludge conveyors 54 such as rotary augers or screws. The rotary screws 54 have a low-profile and are capable of performing some dewatering of sludge S produced by the plate packs 52. The one or more side-by-side rotary screws 54 are housed in one or more side-by-side generally V-shaped troughs 62, each of which has an arcuate apex 64 to match the rotary screw 54 housed therein. The troughs 62 extend axially along a length of a bottom 65 of the clarifier chamber 58.

With regard to the V-shaped troughs 62, solid particles created during flocculation have a high tendency to adhere to surfaces. In order to avoid solids accumulation in the system, plate and side wall surfaces in the clarifier section 50 and sludge thickening section 70 may be angled to exceed the critical angle of repose of the settled material. As a result, an angle ∂ of the plates 51 in the inclined plate packs 52 and walls 63 of the V-shaped troughs 62 are designed to be greater than or equal to 60 degrees from the horizontal.

In embodiments, two or more side-by-side troughs 62 and two or more corresponding rotary screws 54 are used, due to the constraint on the angle ∂ of the V-shaped troughs 62, in order to maximize the volume available for sludge collection, without exceeding the allowable transport dimensions.

Sludge S, formed from particles which settle from the plate packs 52, falls to the rotary screws 54 therein for transport to a distal end 66 thereof, adjacent the thickening section 70. The sludge S is transported from the distal end 66 of the rotary screws, typically via a pump, to the thickening section 70.

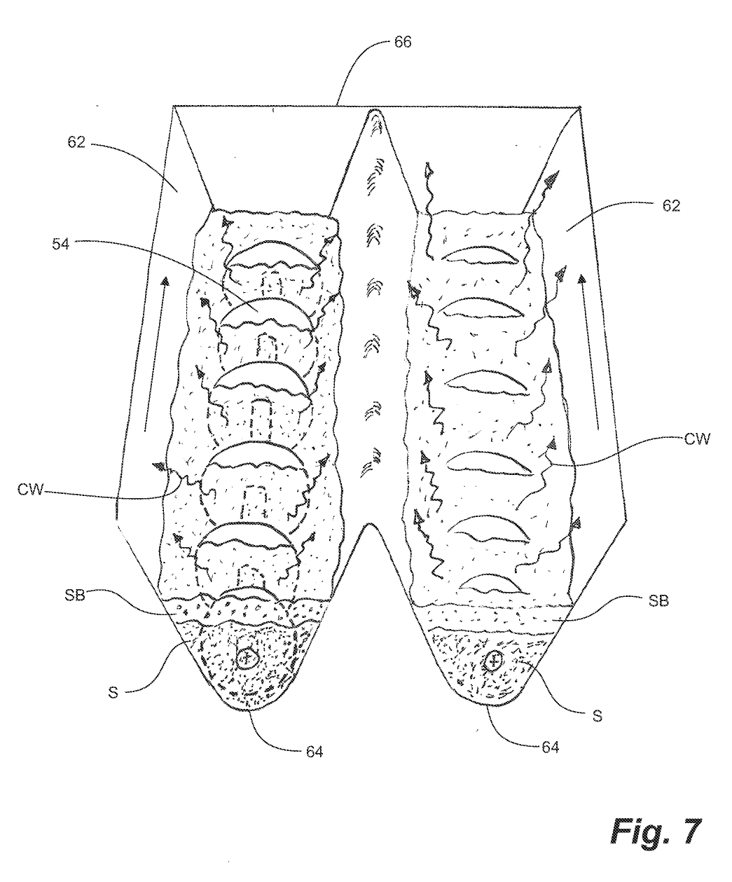

Best seen in FIG. 7, some dewatering of the sludge S occurs in the clarifier section 50 as a further result of the action of flighting 68 of the one or more rotary screws 54 in the one or more V-shaped troughs 62 as the sludge S is moved therealong. As the flighting 68 pushes the sludge S towards the distal end 66, the flighting 68 imparts a small amount of force onto the sludge S and creates channels that allow water to escape upwardly therefrom to rejoin the treated waste water WW_{T} thereabove, resulting in a degree of thickening which is believed comparable to the dewatering performance of conventional clarifier designs. The thickening, which occurs as a result of the dewatering, compensates for the loss of height, and associated gravity settling when compared to the conventional clarifier, required to meet the DOT size limitations.

A continuous motion of the rotary screws 54 in the bottom 65 of the clarifier chamber 58, below the elongated, inclined plate packs 52, facilitates an even distribution of the chemically treated waste water WW_{T} throughout the inclined plate packs 52. The rotary screws 54 create a slow moving sludge blanket SB in the direction of flow of treated waste water WW_{T} therethrough. Conventional clarifiers typically intermittently remove settled solids from a conical bottom and are prone to creating channels in the sludge as the sludge is removed, permitting water above the sludge to be drawn down through the channels. In the embodiments disclosed herein, the continuous, uniform removal of the sludge minimizes the formation of channels in the sludge S and any resulting draw down of clarified water therethrough.

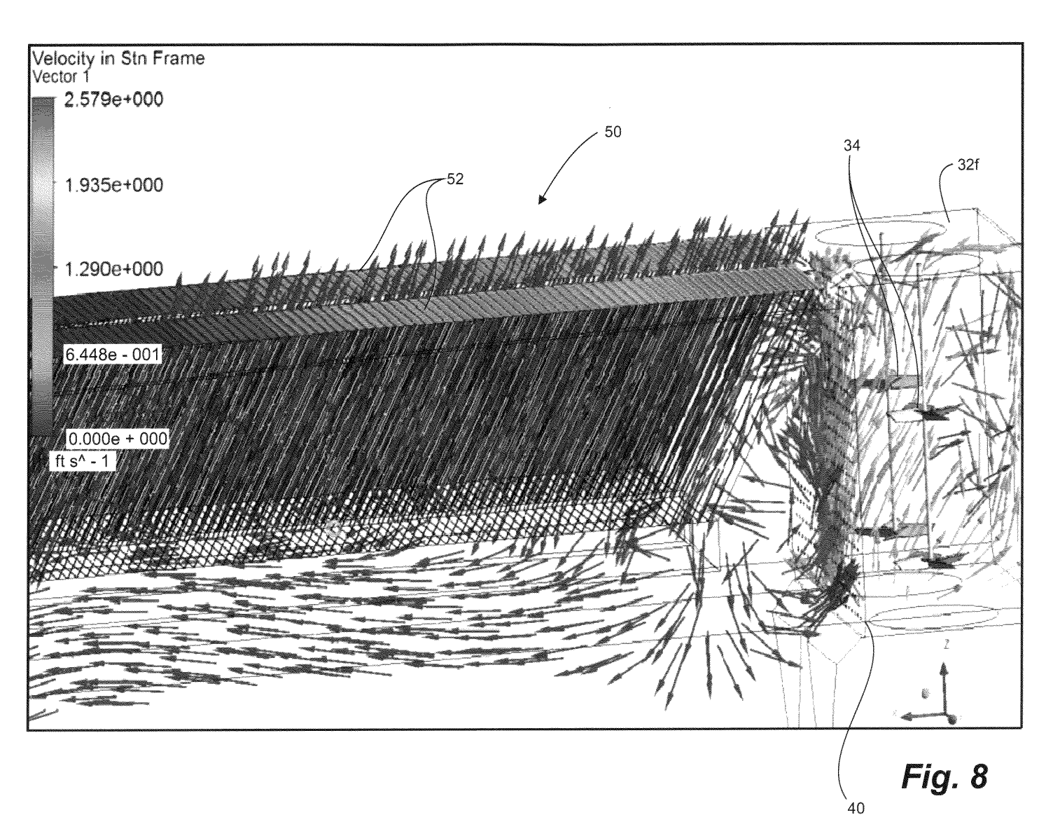

Further, as shown in FIG. 8 using computational fluid dynamics modeling (CFD modeling), the uniform, continuous motion at a slow rate of speed is shown to minimize disruption of the sludge S carried by the rotary screws 54, minimizing the risk of carryover into the clarified water in the clarifier section 50. The speed of the rotary screws 54 is typically determined by the nature and quantity of sludge S produced and can be adjusted accordingly as is understood by those of skill in the art to minimize any disruption in the sludge blanket SB. In embodiments, the rotary screws 54 are driven by variable frequency drives (VFD's) to achieve the slow, uniform, continuous motion.

Up-flow velocity or rate, which is defined as the volumetric flowrate/clarifier surface area, is another parameter which was considered in the design of the clarifier section 50. Lower upflow rates result in improved separation between the solid particles S and the rising liquid L. Generally speaking, larger particles settle faster than small particles. Thus, reducing the upflow rate of waste water flowing through the inclined plate packs 52 and increasing the particle size therein results in an increase in the removal efficiency of the clarifier section 50. For chemically-flocculated solids, such as are formed in embodiments of the system, maintaining an upflow rate of less than 0.05 ft/s through the inclined plate packs 52 results in high solids removal efficiency.

A common problem in conventional inclined plate clarifiers is an uneven flow distribution to the inclined plate pack and flow channeling to different sections of the plate pack. Flow channeling results in higher upflow rates in certain portions of the plate pack and can significantly reduce plate pack effectiveness and reduce capacity. The elongated plate pack 52, according to embodiments described herein, presented a significant challenge in this respect.

To overcome flow channeling and ensure a relatively even flow distribution throughout the one or more plate packs 52, a baffle 55 located at a lower, front edge 57 of the one or more plate packs 52 and the plates 51 in the inclined plate packs 52 are oriented with a bottom 51b of each plate 51 positioned away from the inlet 38 from the chemical section 30 and a top 51t toward the inlet 38.

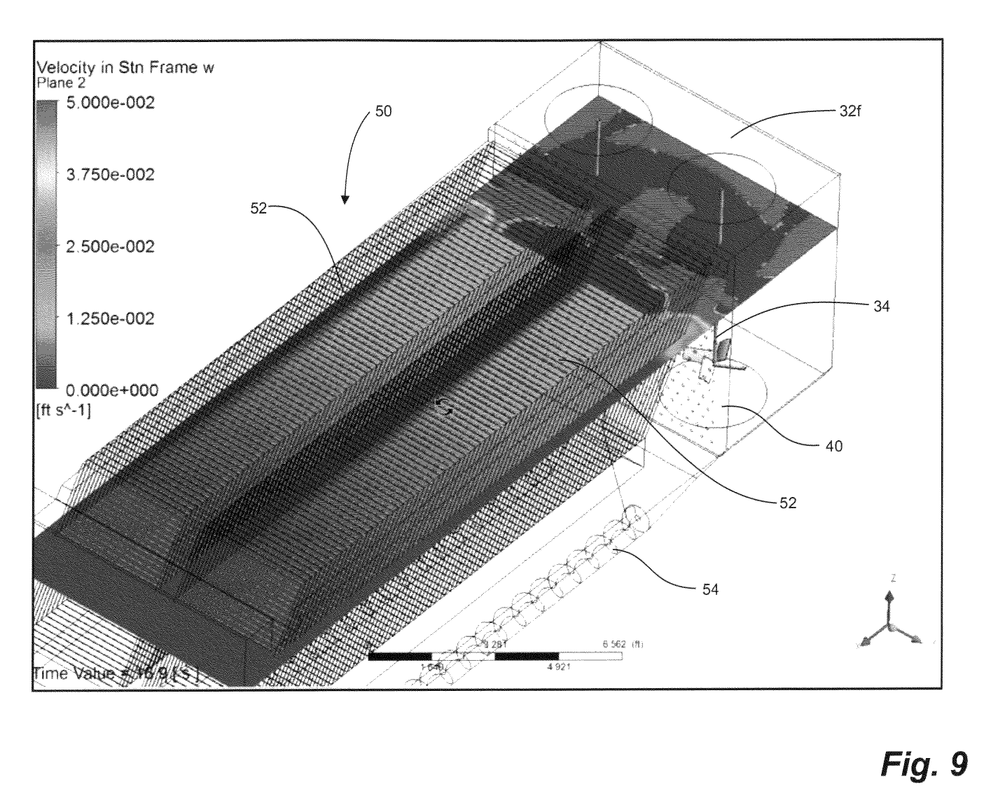

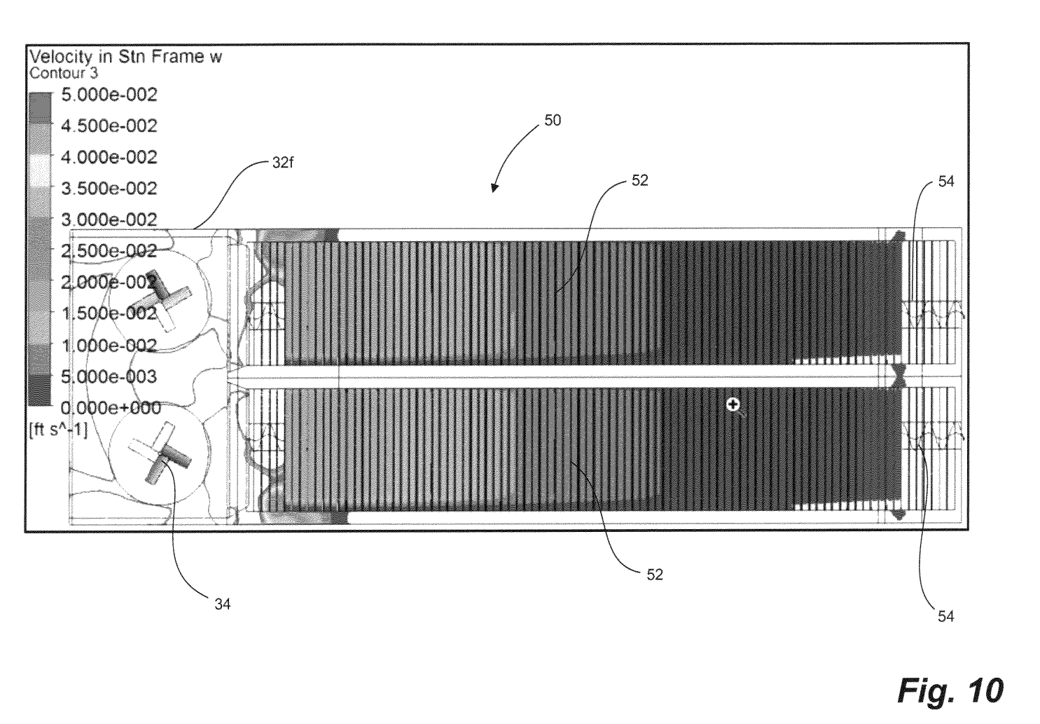

Having reference to the CFD modeling, shown in FIG. 9 and FIG. 10, and as a result of this configuration, the amount of channeling in the one or more plate packs 52 is reduced and a more uniform upflow rate is maintained. Additional adjustments can be made to a height and angle of the collection weirs 53 discharging to a decanting weir 53d at the distal end 66 of the clarifier section 50 to compensate for flow inequalities during operation.

Conventional clarifier designs typically contain one or two large outlets from a flocculation chamber through which the treated waste water enters the clarifier section. CFD modeling of the conventional clarifiers has shown that such large-area conduits convey a significant amount of momentum to the treated waste water flowing between the flocculation chamber and the plate pack section. The significant amount of momentum creates currents, within the clarifier, which result in a poor distribution of flow and localized turbulence beneath the plate pack in the clarifier which affect operation of the clarifier.

Applicant believes that steady, laminar flow across a boundary between the flocculation chamber 32f and the clarifier section 50 improves the solids separation in the clarifier section 50. As mentioned above, the stilling plate 40 reduces turbulence in the incoming treated waste water WW_{T}. Further, the reduction in turbulence is accomplished, as much as possible, without creating an inhibitory pressure drop between the flocculation chamber 32f and the clarifier section 50.

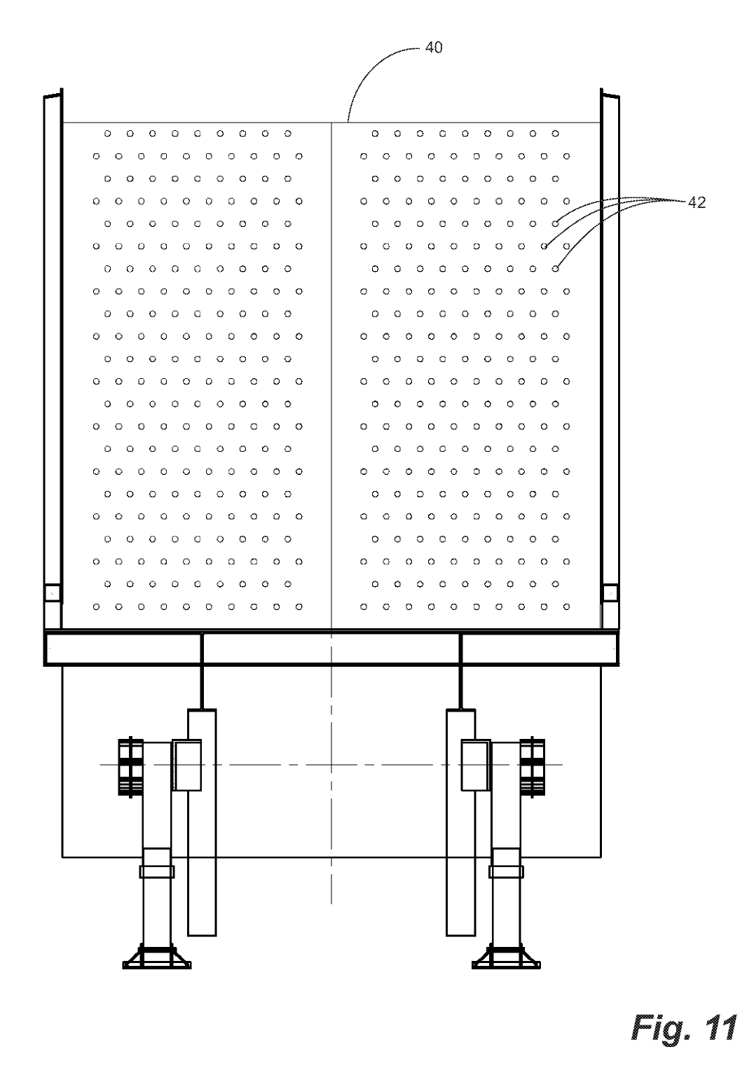

Best seen in FIG. 11, the stilling plate 40 comprises a plurality of perforations or orifices 42 therethrough to dissipate the energy imparted to the waste water WW by the mixing action in the flocculation chamber 32f.

One of skill in the art will appreciate that modeling can be done for different waste water streams, depending upon the characteristics of the waste water WW and the flocculent added, to determine an optimum number and diameter of the orifices 42 in the stilling plate 40 to minimize the pressure drop thereacross. In one embodiment, the stilling plate 40 comprises 418, one inch orifices, formed through the plate 40.

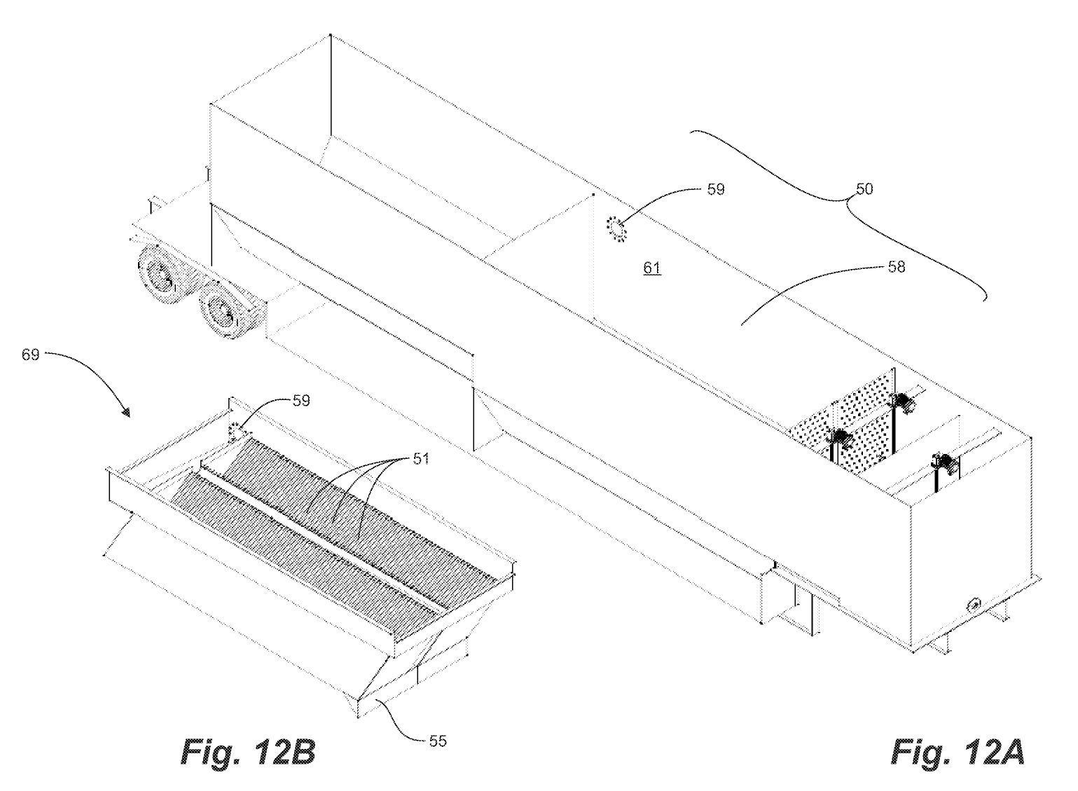

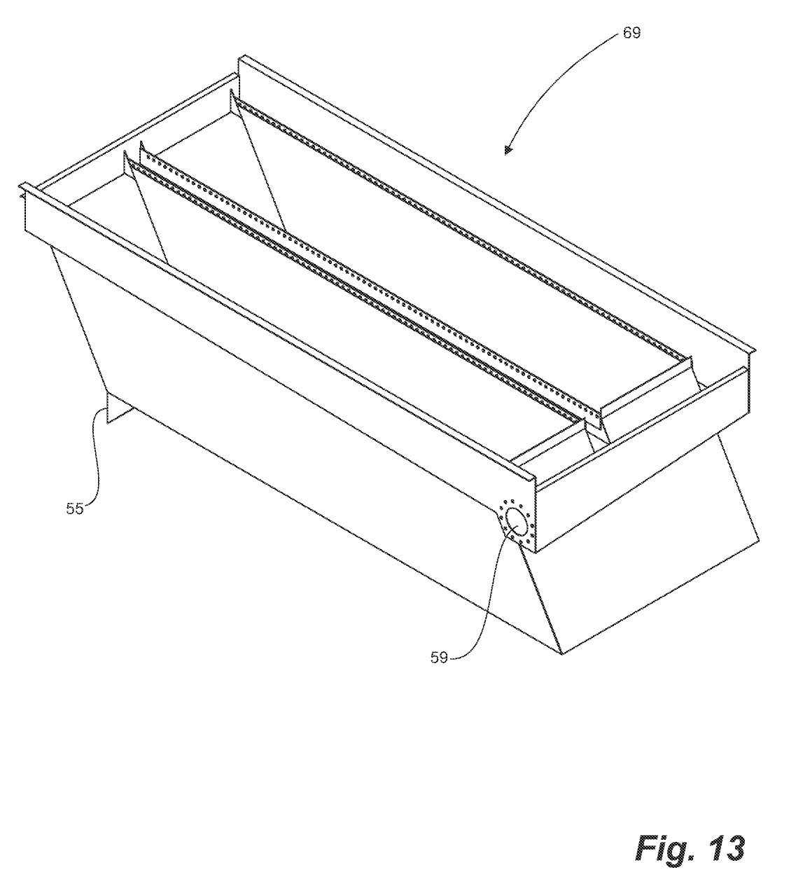

As shown in FIGS. 12A, 12B and 13, to improve the serviceability of the clarifier section 50, an elongate plate-carrying box 69, which supports the inclined plates 51 in the chamber 58, is removable. An entire plate pack 52 can be removed from the bed 16 of the trailer 12 to allow easy access to the lower portion 60 of the chamber 58 for cleaning and servicing of the sludge conveyors 54 therebelow.

Having reference again to FIGS. 12A to 13, making the inclined plate packs 52 removable created a challenge with respect to the flow through the system 10. In one embodiment, the clarifier plate packs 52 are supported entirely in the chamber 58 by outside, peripheral walls 61 of the clarifier chamber 58. Eliminating the need for supports below the plate pack 52 minimizes interference with the flow therethrough and eliminates potential locations for sludge S accumulation in the clarifier section 50. Typically, the V-shaped troughs 62 are positioned a minimum vertical clearance therebelow allowing for flow of treated waste water WW_{T} and the settling of sludge S therebetween.

### Thickening Section

Having reference again to FIGS. 1 to 5B and best seen in FIGS. 2 and 4, a large portion of the thickening tank or section 70 is supported above the central drop-bed section 20 of the trailer 12 and a distal end 71 of the thickening section 70 is supported on the raised distal end 22 of the truck-bed 16 over the wheels 24. Pumping equipment 72 housed in an equipment space 23 formed between the dropped section 20 of the trailer 12 and a bottom 74 of the thickening section 70, pumps sludge S from the distal end 66 of the clarifier screws 54 to the thickening section 70. The equipment space 23 below the thickening section 70 is effectively utilized for housing the pumping equipment 72 and the like, that would otherwise displace useful clarifying or thickening treatment volumes. The sludge S in the thickening section 70 is thickened largely by the weight of the sludge S acting, by gravity, to separate solids from water in the sludge S.

As shown in FIG. 5B, like the clarifier section 50, one or more side-by-side generally V-shaped troughs 73 extend axially along the bottom 74 of the thickening section 70. Walls 75 of the one or more V-shaped troughs 73 are angled greater than or equal to 60 degrees from the horizontal, being greater than the critical angle of repose of the thickened sludge S settling therein. As for the clarifier section 50, in order to maintain a low profile while retaining the wall angle ∂, more than one V-shaped trough 73 may be provided. A linear conveyor 76, such as a low profile rotary auger or screw, is housed in each of the V-shaped troughs 73 for moving thickened sludge S to a distal end 77 thereof for transport, such as by pump, to dewatering equipment on the second, auxiliary trailer 14. In embodiments, two or more V-shaped troughs 73 and associated rotary screws 76 are used. Like the generally V-shaped troughs 62 in the clarifier section 50, the troughs 73 in the thickening section 70 each have an arcuate apex 64 for accommodating the rotary screws therein.

In one embodiment, shown in FIG. 4, the pumping equipment or pump-out box 72, located below the thickening section 70, collects sludge S from the clarifier section 50 and discharges the sludge S to an inlet 78 at a point about midway along a length and height of the thickening section 70 so as to avoid disruption of a sludge blanket SB forming in the troughs 76 therebelow and clarified water CW thereabove. Discharge of the sludge S at the mid-point inlet 78 avoids flowback of the discharged sludge S to the clarifier section 50, but creates a flow impetus toward the clarifier section 50 to cause a small amount of clarified water CW from the thickening section 70 to overflow a weir 80 between the clarifier section 50 and the thickening section 70 for recirculation back to the clarifier section 50. The low-solids water discharge or flowback to the clarifier section 50 acts to further dewater the thickening sludge S. The flowback returns to the clarifier section 50 by gravity flow, without the need for additional pumping power and the associated loss of valuable treatment volume.

In summary, the liquid portion of the waste water WW flows through the chemical mixing section 30 and through the stilling plate 40 to the clarifier section 50. Clarified liquid, from the inclined plates 51 and the rotary screws 54, progresses through the inclined plates 51 to collect in the transverse, decanting weir 53d at a distal end 66 of the plate box 69 for discharge as clarified water CW from the water outlet 59, intermediate the pin end 18 and the distal end 22 of the first trailer 12. Some liquid released in the thickening section 70 is decanted into the clarifier section 50 adjacent the distal decanting weir 53d for additional processing through the plate pack 52.

The solids-laden portion of the waste water WW progresses through the chemical mixing section 30 and settles as sludge S into the clarifier's V-shaped troughs for transport to the thickening section 70. The sludge S from the clarifier section 50 is delivered intermediate the thickening section 70 and is transported therein to the distal end 22 of the first trailer 12. The sludge S is transported from the distal end 22 of the first trailer 12 to the second, auxiliary trailer 14 and is received by the dewatering equipment 90 thereon. Pump boxes 79 are used to pump the sludge S to the dewatering equipment 90 on the second trailer 14.

As can be appreciated, well pads 100 on which the system 10 is operated on-site typically do not provide a leveled concrete foundation. As shown in FIG. 2, at least the first, clarifier trailer 12 is equipped with a number of leveling jacks 102 which can be adjusted, as needed, to compensate for any unevenness of the well pad 100. In addition, the collection weirs 53, are designed to be adjustable for angle and height, ensuring even flow to all areas of the one or more clarifier plate packs 52. The combination of the leveling features ensures that flow can be evenly distributed through the clarifier section 50, allowing the system 10 to operate at full capacity, regardless of variability in site preparation.

### Auxiliary Trailer

Having reference again to FIGS. 1A and 1B, a second road-transportable trailer-bed, the auxiliary trailer 14, houses at least the dewatering apparatus 90 for further dewatering the thickened sludge S received from the first, clarifier trailer 12. In one embodiment, the dewatering apparatus 90 is a filter press which receives the pumped, thickened sludge S from the first, clarifier trailer 12. Filter cake FC from the filter press 90 is transported from the auxiliary trailer 14 to an onsite storage bin 92, such as located adjacent the second trailer 14. The filter cake FC is removed from bin 92 and transported to a disposal site. The permeate, or clarified water CWF from the filter press 90, is combined with the clarified water CW from the clarifier section 50.

Further, the second, auxiliary trailer 14 houses a lift tank 94 which receives clarified water CW from the transverse, distal decanting weir 53d through the water outlet 59 on the first, clarifier trailer 12 and clarified water CWF from the filter press 90. The clarified water CW is received by gravity through piping or conduits 95, removeably connecting between the water outlet 59 of the first trailer and the lift tank 94 on the second trailer 14. The clarified water CW can be pumped from the lift tank 94 for storage or re-use on the well site.

Additionally, the second auxiliary trailer 14 houses chemical storage tanks 96 for providing coagulant, flocculant and the like to the chemical mixing section 30 on the first trailer 12 and a control room 98 for controlling the operation of the system and apparatus 10 on both the first and second trailers 12,14.

Removeable fluid and electrical connections permit communication between the variety of apparatus on each of the two trailers 12,14 and permit rapid set-up and decommissioning of the system 10 for transport between sites.

### In Use

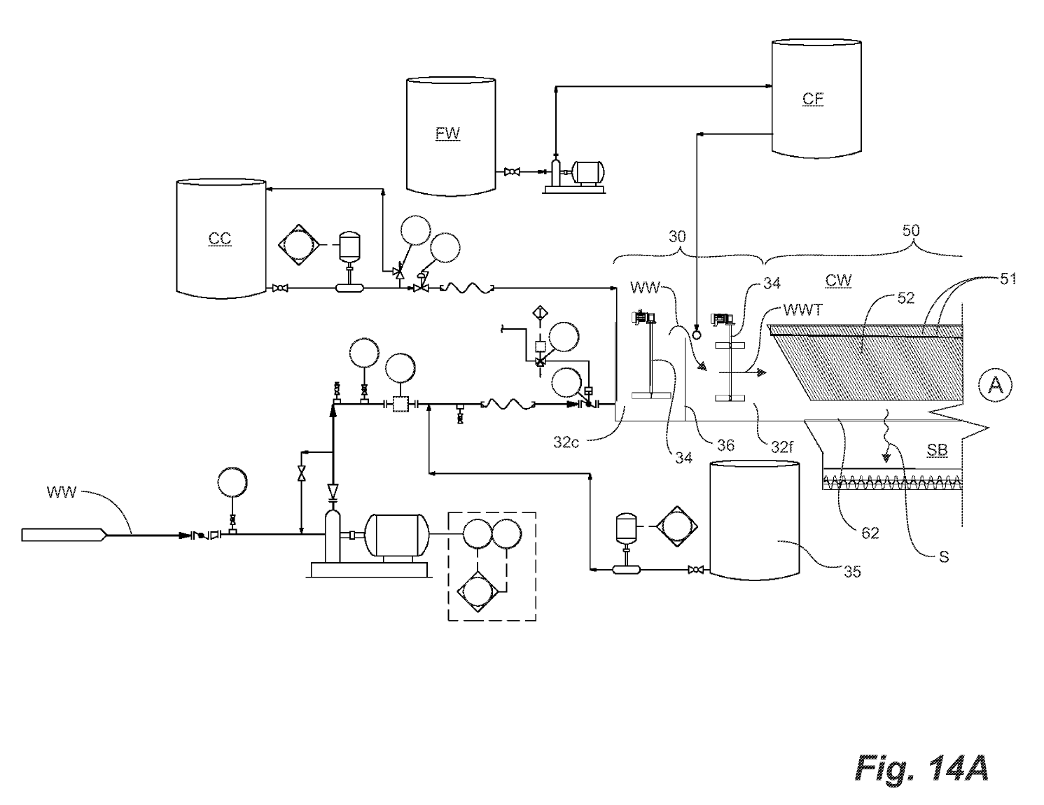

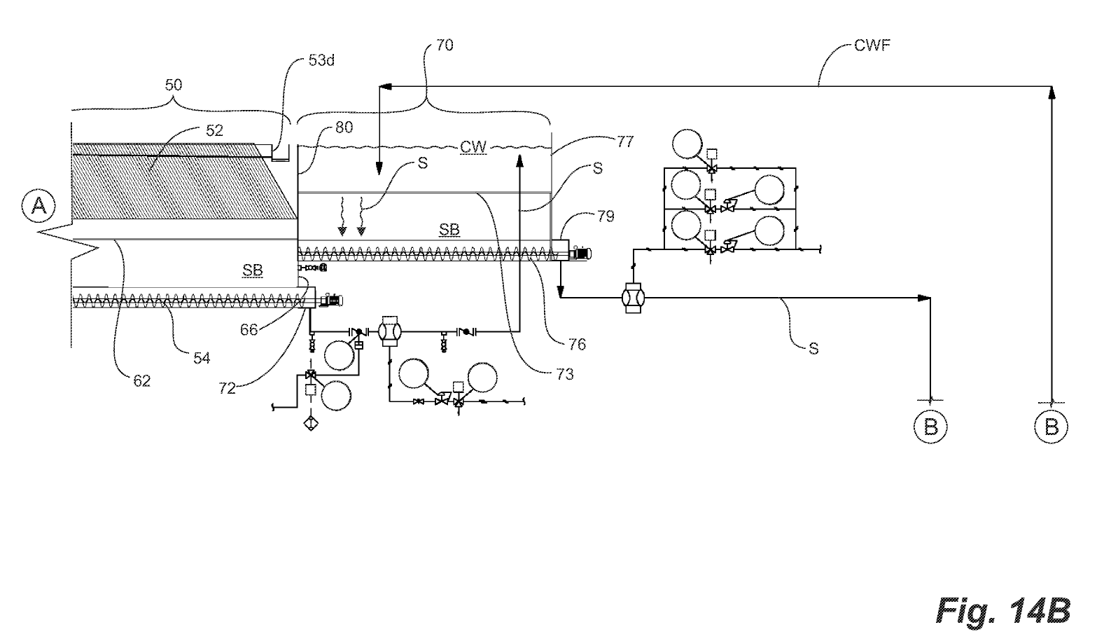

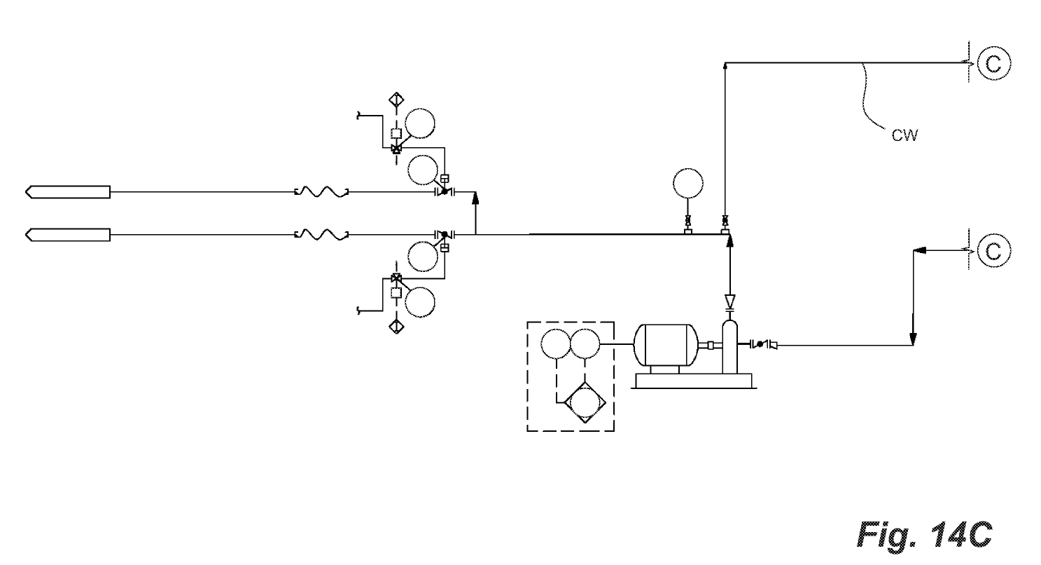

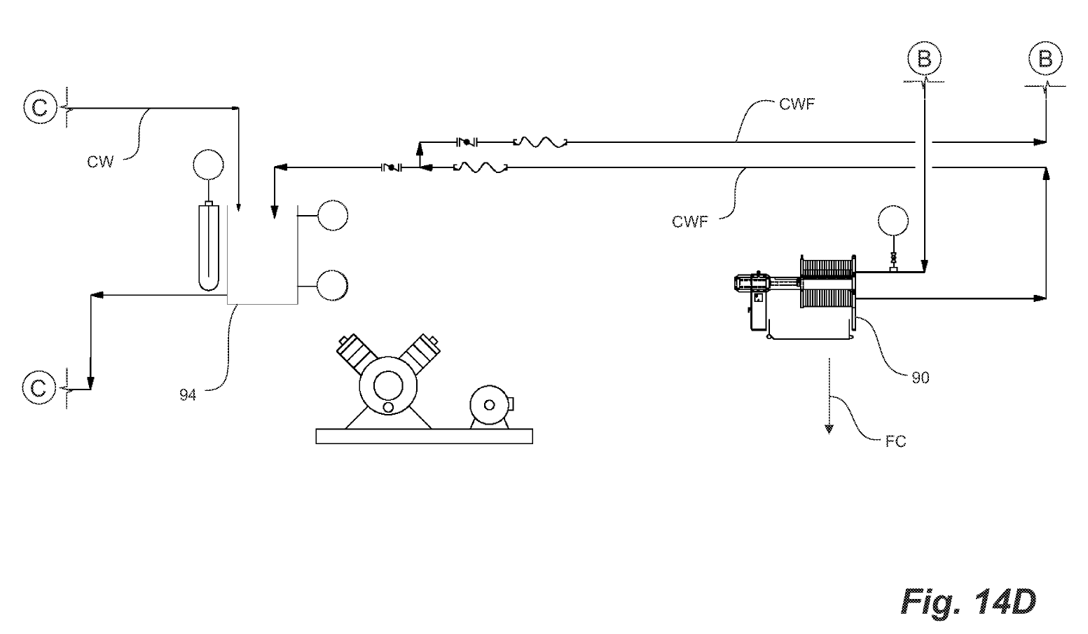

With reference to FIG. 4 and FIGS. 14A to 14C, in one embodiment, waste water WW is pumped into the coagulation chamber 32c where the chemical coagulant is added and mixed therein. The coagulant-treated waste water WW overflows the weir 36 into the flocculation chamber 32f where the flocculent is added and mixed therein for contacting the particles and aiding in floc formation. The chemically treated waste water WW_{T}, which is a solid-liquid slurry, passes from the flocculation chamber 32f to the clarifier section 50, turbulence being dissipated therein.

Optionally, as shown in FIG. 14A and 14B, the pH of the waste water WW can be elevated, such as by adding sodium hydroxide 35. The elevated pH enables existing metal salts in the waste water WW to act as coagulants.

Clarified water CW, which results after the solids fall by gravity along the inclined plates 51 in the plate packs 52, flows up through the one or more plate packs 52 and into collection weirs 53 thereabout at the top of the clarifier section 50. The clarified water CW flows from the collection weirs 53 into the transverse, distal decanting weir 53d at the distal end 66 of the clarifier section 50 for discharge from the water outlet 59.

The solid particles or sludge S sinks toward the bottom 65 of the clarifier section 50 and is collected in the V-shaped troughs 62. The screws 54 therein are moved continuously and uniformly at a slow speed so as to avoid disrupting a sludge blanket SB which forms therein. The screws 54 slowly draw the settled sludge S to the pump-out box 72 at the distal end 66 thereof. The screws 54 operate substantially continuously, resulting in unfettered removal of solids S.

The relatively high-solid sludge S is pumped, from the pump-out box 72 into the sludge thickening section 70. The thickening section 70 allows the solids to compact under their own weight, resulting in a TSS gradient in the thickening section 70, with water containing the lowest concentration of solids at the surface. As sludge S is pumped into the thickening section 70, the low TSS or clarified water CW at the top of the thickening section 70 is decanted over the weir 80 therebetween and back into the clarifier section 50 to flow under the plate packs 52. The thickening section 70 is also equipped with steep V-shaped troughs 73 housing the rotary screws 76 which help to compress the solids and transfer the sludge S into a set of pump out boxes 79 at the distal end 77 thereof.

The thickened sludge S is pumped from the pump out box 79 on the clarifier trailer 12, into the filter press 90, located on the second, auxiliary trailer 14, for dewatering. The resultant filter cake FC forms a dense solid which can be safely transported to a suitable disposal facility. At the start of operation, the filter permeate CWF may contain some solids S and therefore can be directed to the thickening section 70 on the first, clarifier trailer 12. Thereafter, when the quality of the permeate CWF is satisfactory, the permeate CWF is directed to the lift tank 94 where it combines with the clarified water CW from the clarifier plate pack 52.

The clear, clarified water CW from the transverse decanting weir 53d, flows by gravity into the lift tank 94 from which the clarified water CW is typically pumped to a designated holding tank on the well pad 100 for reuse at the well site.

Thus, embodiments disclosed herein produce two products; clarified water CW for reuse and dewatered solids S for disposal.

In one example of clarification of waste water using an embodiment of the system, the incoming waste water stream WW comprises less than about 1000 ppm of solid. The sludge S leaving the clarifier section 50 comprises about 0.5% to about 1.5% solid/wt and the thickened sludge S leaving the thickening section 70 comprises about 3% to about 5% solid/wt. Following dewatering, the filter cake from the filter press comprises about 20% solid/wt to about 35% solid/wt.

### EXAMPLE

The first clarifier trailer is a semi-trailer bed having a total length of about 53 feet and a total width of about 8.5 feet. The raised pin end of the trailer-bed has a length of about 10 feet and a usable height of about 9.5 feet. The central drop-bed portion has a length of about 33 feet and a usable height of about 11.5 feet and the raised rear portion, over the distal wheels, has a length of about 10 feet and a usable height of about 9.5 feet.

The chemical section comprises the coagulation chamber and the flocculation chamber, each of which is about 5 feet in length and about 8 feet in height, and is mounted on the raised pin end of the trailer-bed.

The low-profile clarifier section which is housed largely in the drop-bed portion has a total usable height of about 11.5 feet and a length of about 20′. The thickening section is about 9.5′ in height and forms the space therebeneath in the remainder of the drop-bed portion which is about 22 inches in height for housing pumping apparatus and the like.

Stairs to reach the top of the unit as well as tanks and other auxiliary equipment are mounted on the remainder of the raised distal end of the trailer-bed which is about 6′ in length.

Having reference again to FIGS. 12A and 12B, the generally V-shaped troughs 62,73 in the bottom of both the clarifier (FIG. 12A) and the thickening sections (FIG. 12B) are about 45 inches tall. Inner, adjacent walls of each of the troughs 62,73 are angled about 70° from horizontal while outer walls are angled about 60° from horizontal.

The embodiments of the invention in which an exclusive property or privilege is claimed are defined as follows:

1. A mobile, waste water treatment system comprising:
a first trailer having
a chemical chamber for mixing chemicals with a waste water stream for forming a treated waste water stream;
an elongate, low-profile clarifier section for receiving the treated waste water stream therein, the clarifier section comprising:
a clarifier chamber having one or more elongate, inclined plate packs supported therein, the clarifier chamber being fluidly connected to the two or more chemical chambers for receiving the treated waste water stream therefrom;
a water outlet for discharging clarified water from the top of the clarifier chamber;
one or more longitudinally extending, low-profile, steep-walled, generally V-shaped troughs in a bottom of the clarifier chamber for collecting sludge settling therein; and
one or more linear conveyors positioned in the one or more generally V-shaped troughs for moving the sludge, longitudinally therealong, to a distal end; and
a thickening section comprising:
a thickening chamber for receiving the sludge from the clarifier chamber's distal end at a mid-point inlet, midway a length and height of the thickening chamber;
one or more longitudinally extending, steep-walled, generally V-shaped troughs in a bottom of the thickening chamber for collecting thickened sludge depositing therein;
one or more linear conveyors in the one or more generally V-shaped troughs for moving the thickened sludge longitudinally therealong to a sludge outlet; and
a low-solids water discharge from a top of the thickening section to the clarifier chamber; and
a second trailer having at least dewatering apparatus for receiving the thickened sludge from the thickening section on the first trailer and for removing water therefrom.

2. The system of claim 1 wherein the first trailer comprises:
a shaped trailer-bed having a raised proximal end positioned over a pin end of the trailer, a central drop-bed section and a raised distal end positioned over wheels at the distal end of the trailer; and wherein
the elongate, low-profile clarifier section is positioned in the central drop-bed section for maximizing a height thereof within transportable limits.

3. The system of claim 2 wherein,
the chemical chamber is supported on the raised proximal end of the shaped trailer-bed; and
the thickening section spans a portion of the central drop-bed section and the raised distal end of the trailer-bed and forming an equipment space therebelow.

4. The system of claim 1 wherein the treated waste water stream flows through the inclined plate packs at an upflow rate of less than about 0.05 ft/s.

5. The system of claim 1 wherein the chemical chamber comprises at least two fluidly connected chemical chambers comprising:
at least one coagulation chamber for adding a coagulant for destabilizing solids in the waste water, the at least one coagulation chamber having one or more mixers therein; and
at least one flocculation chamber, downstream from the at least one coagulation chamber and receiving the waste water stream therefrom, for adding a flocculant to increase a particle size of the solids for aiding settling, the at least one flocculation chamber having one or more mixers therein.

6. The system of claim 5 further comprising:
a weir between the at least one coagulation chamber and the at least one flocculation chamber for fluidly connecting therebetween.

7. The system of claim 1 wherein the elongate, low-profile clarifier section further comprises:
an elongate plate-carrying box supported in the clarifier chamber for supporting the one or more elongate, inclined plate packs therein above the one or more low-profile V-shaped troughs.

8. The system of claim 7 wherein the elongate plate-carrying box is supported from peripheral walls of the clarifier chamber for maximizing a space between a bottom of the one or more elongate, inclined plate packs and a bottom of the clarifier chamber for minimizing interference of flow therebelow.

9. The system of claim 7 wherein the elongate plate-carrying box is removable for servicing and cleaning of the clarifier chamber.

10. The system of claim 4 further comprising:
collection weirs positioned about each of the one or more elongate, inclined plate packs, the collection weirs being fluidly connected to a transverse, distal, decanting weir for collection and discharge of the clarified water therefrom to the water outlet.

11. The system of claim 1 wherein the one or more low-profile V-shaped troughs are spaced a minimum vertical clearance from a bottom of the one or more elongate, inclined plate packs for minimizing interference of flow therebetween.

12. The system of claim 1 wherein the one or more V-shaped troughs further comprise walls angled about 60 degrees or greater from horizontal.

13. The system of claim 1 wherein the one or more V-shaped troughs are two or more side-by-side troughs for maximizing a volume available for the sludge, settling therein.

14. The system of claim 1 wherein the one or more linear conveyors move continuously below the elongate, inclined plate packs to create a sludge blanket which moves in a direction of flow of the waste water for minimizing channeling and draw down of clarified water therethrough.

15. The system of claim 1 wherein the one or more linear conveyors are rotary screws and wherein a force of flighting of the one or more rotary screws, acting on the sludge in the one or more V-shaped troughs, causes water to be released from the sludge into the waste water thereabove.

16. The system of claim 1 further comprising:
a baffle at a lower, front edge of the one or more elongate, inclined plate packs for ensuring even flow distribution of the treated waste water stream to the one or more elongate, inclined plate packs.

17. The system of claim 1 wherein inclined plates in the one or more elongate, inclined plate packs are oriented to direct flow discharged therefrom upstream toward an inlet from the two or more chemical chambers for minimizing channelling in the one or more elongate, inclined plate packs.

18. The system of claim 5 wherein the clarifier section further comprises:
a stilling plate forming an inlet between the flocculation chamber and the clarifier chamber, the stilling plate having a plurality of orifices therein for creating a laminar flow of the treated waste water stream from the flocculation chamber to the clarifier chamber for minimizing turbulence therein and for minimizing a pressure drop therebetween.

19. The system of claim 3 further comprising:
pumping apparatus positioned in the equipment space for pumping the sludge from the distal end of the one or more V-shaped troughs in the clarifier chamber to the thickening section.

20. The system of claim 19 wherein the sludge is pumped to a point midway along the length of the thickening section to create a flow impetus causing the low-solids water discharge from the thickening section to the clarifier section for further dewatering the sludge.

21. The system of claim 1 further comprising an overflow weir between the thickening chamber and the clarifier chamber, the low-solids water being discharged thereover from the thickener chamber to the clarifier chamber by gravity.

22. The system of claim 1 wherein the at least dewatering apparatus on the second trailer comprises:
a filter press, wherein
clarified water produced therefrom being combined with the clarified water from the clarifier chamber; and
filter cake produced therefrom being sent for disposal.

23. The system of claim 1 wherein the second trailer further comprises:
a lift tank for receiving the clarified water from the water outlet on the first trailer.

24. The system of claim 1 wherein the second trailer comprises:
chemical storage tanks removably fluidly connected to the chemical chamber on the first trailer.

25. The system of claim 1 wherein the second trailer further comprises:
a control room for controlling operation of the mobile, waste water treatment system.

26. The system of claim 1 wherein the second trailer further comprises:
pumps for moving the thickened sludge from the thickening section on the first trailer to the at least dewatering apparatus on the second trailer.

27. The system of claim 1 wherein the first trailer and the second trailer are sized to be road transportable.

28. A method for integrating a waste water treatment system on at least one road-transportable trailer-bed, the method comprising:
providing a trailer-bed having a raised pin-end, a central drop-bed portion and a raised distal end;
positioning chemical chambers over the raised pin-end of the trailer-bed;
positioning a clarifier section, comprising one or more elongate, inclined plate packs supported therein, in the central drop-bed portion adjacent the two or more chemical treatment chambers and fluidly connected thereto, the clarifier section having a height sufficiently low so as to be within unpermitted road transport allowance, the clarifier section having one or more longitudinally-extending, linear, V-shaped troughs having linear conveyors extending along a bottom thereof positioned below the one or more elongate, inclined plate packs for receiving and transporting sludge collected therein; and
positioning a thickening section downstream from the clarifier section and fluidly connected thereto, the thickening section spanning between a remaining portion of the central drop-bed portion and the raised distal end, forming an equipment space in the central drop-bed portion therebelow, the thickening section having one or more longitudinally-extending, linear, V-shaped troughs having the linear conveyors therein for receiving and transporting the sludge collected therein, wherein
the linear conveyors in the clarifier section and thickening section are moved at a slow, uniform, continuous rate of speed for minimizing disturbance of the sludge therein when transported thereby.

29. The method of claim 28 further comprising:
pumping the sludge from the clarifier section to the thickening section using pumping equipment housed in the equipment space below the thickening section.

30. The method of claim 28 further comprising:
providing a second road-transportable trailer-bed having at least a lift tank; and
discharging clarified water from the clarifier section to the lift tank.

31. The method of claim 30 further comprising:
mounting dewatering apparatus on the second road-transportable trailer-bed; and
pumping sludge, from a distal end of the one or more longitudinally extending V-shaped troughs and the linear conveyors therein in the thickening section, to the dewatering apparatus for producing dewatered solids.
